(19) United States
(12) Patent Application Publication
(10) Pub. No.: US 2017/0337222 A1
(43) Pub. Date: Nov. 23, 2017

(54) IMAGE SEARCHING METHOD AND APPARATUS, AN APPARATUS AND NON-VOLATILE COMPUTER STORAGE MEDIUM

(71) Applicant: BAIDU ONLINE NETWORK TECHNOLOGY (BEIJING) CO., LTD., Beijing (CN)

(72) Inventors: Xiaotian XU, Beijing (CN); Siyu HOU, Beijing (CN); Yan JIANG, Beijing (CN)

(73) Assignee: BAIDU ONLINE NETWORK TECHNOLOGY (BEIJING) CO., LTD., Beijing (CN)

(21) Appl. No.: 15/524,544

(22) PCT Filed: Nov. 11, 2015
(86) PCT No.: PCT/CN2015/094339

§ 371 Date: May 4, 2017

(30) Foreign Application Priority Data
May 18, 2015 (CN) 201510253333.X

(51) Int. Cl. G06F 17/30

(52) U.S. Cl. CPC G06F 17/30256; G06F 17/3053; G06F 17/30277; G06F 17/3028

(57) ABSTRACT

The present disclosure provides a image searching method and apparatus, an apparatus and a non-volatile computer storage medium. The method comprises: acquiring a image to be searched and search intention information with respect to the image to be searched; obtaining a search result according to the image to be searched and the search intention information. The present disclosure may improve the efficiency in acquiring useful information from the search results.

The present disclosure claims priority to the Chinese patent application No.201510253333.X entitled “Image Searching Method and Apparatus” filed on the filing date May 18, 2015, the entire disclosure of which is hereby incorporated by reference in its entirety.

### FIELD OF THE DISCLOSURE

The present disclosure relates to the technical field of information search, and particularly to a image searching method and apparatus, an apparatus and a non-volatile computer storage medium.

### BACKGROUND OF THE DISCLOSURE

As the Internet technology develops, currently the user already is not contented to only search for a text, and many users also wish to search for network images via a search engine and therefore image search technology occurs.

The current image searching technology mostly relates to only performing comparison processing for images and searching to obtain similar image results and text result and the like. At present, such image searching technology cannot accurately understand the user's demands, usually many search results are returned, the user needs to constantly search from the search results and usually cannot quickly obtain desired information therefrom, and an efficiency for obtaining useful information is low.

### SUMMARY OF THE DISCLOSURE

A plurality of aspects of the present disclosure provide a image searching method and apparatus, an apparatus and a non-volatile computer storage medium, to improve an efficiency for obtaining useful information from search results.

According to an aspect of the present disclosure, there is provided a image searching method, comprising:

acquiring a image to be searched and search intention information with respect to the image to be searched;

obtaining a search result according to the image to be searched and the search intention information.

According to another aspect of the present disclosure, there is provided a image searching apparatus, comprising:

an acquiring module configured to acquire a image to be searched and search intention information with respect to the image to be searched.

a searching module configured to obtain a search result according to the image to be searched and the search intention information.

According to a further aspect of the present disclosure, there is provided an apparatus, comprising

one or more processors;

a memory;

one or more programs stored in the memory and configured to execute the following operations when executed by the one or more processors:

acquiring a image to be searched and search intention information with respect to the image to be searched;

obtaining a search result according to the image to be searched and the search intention information.

According to a further aspect of the present disclosure, there is provided a non-volatile computer storage medium in which one or more programs are stored, an apparatus being enabled to execute the following operations when said one or more programs are executed by the apparatus:

acquiring a image to be searched and search intention information with respect to the image to be searched;

obtaining a search result according to the image to be searched and the search intention information.

In the present disclosure, the image to be searched and the search intention information with respect to the image to be searched are obtained, and meanwhile, the search results are obtained simultaneously according to the image to be searched and the search intention information. Since search is performed simultaneously according to the image to be searched and the search intention information, the obtained search result is a search result which is closest to the user's search intention. As compared with the prior art, the present disclosure substantially reduces the number of search results and therefore may improve the user's efficiency in acquiring useful information from the search results.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1 is a flow chart of a image searching method according to an embodiment of the present disclosure;

FIG. 2 is a block diagram of an apparatus for searching for images according to an embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

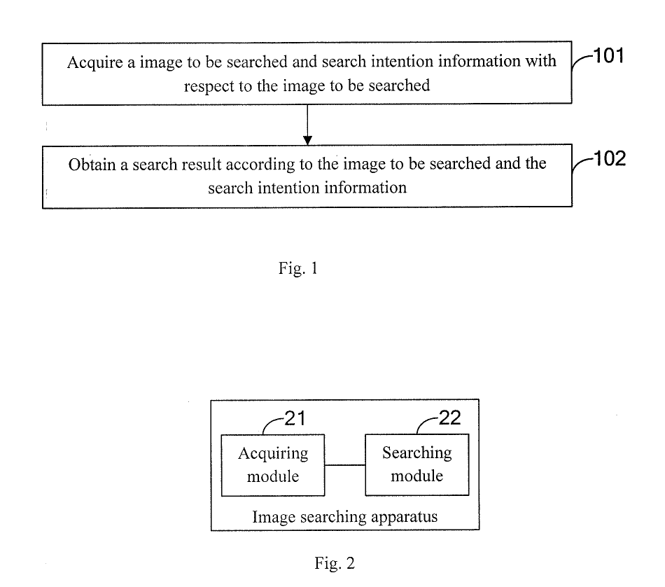

FIG. 1 is a flow chart of a image searching method according to an embodiment of the present disclosure. As shown in FIG. 1, the method comprises:

101: acquiring a image to be searched and search intention information with respect to the image to be searched.

102: obtaining a search result according to the image to be searched and the search intention information.

With respect to problems with the current image search such as failure to accurately understand the user's demands, a large number of search results and a lower efficiency of the user obtaining useful information from the search results, the present embodiment provides a image searching method, specifically as follows:

When image search needs to be performed, a image searching apparatus obtains a image to be searched, and acquires search intention information for the image to be searched, and then performs search simultaneously according to the image to be searched and the search intension information to thereby obtain a search result relevant to the image to be searched and satisfying the search intention.

The search intention information of the image to be searched mainly represents the user's search intention or search demands for the image to be searched. Generally, the information relevant to the image to be search is a very large amount, information incompliant with the search intention is filtered away from all information relevant to the image to be searched through the search intention information to reduce the information amount. A image of vegetable is taken as the image to be searched. Information relevant to the image comprises: heat information, recipe information, purchase information, relevant news and comprehensive and encyclopedia information of the vegetable, and the like. Suppose that the user's search intention for this vegetable is to search for information of place of origin, as compared with the amount of information relevant to the vegetable, information simultaneously relevant to the vegetable and the place of origin of the vegetable is in a much less amount. For example, information simultaneously relevant to the vegetable and the place of origin of the vegetable might include related news, comprehensive and encyclopedia information, and the like of the vegetable, and does not include heat information and recipe information of the vegetable.

As known from the above, in the present embodiment, a search result being relevant to the image to be searched as well as satisfying the search intention information may be directly acquired by performed search by taking the image to be searched as a search result and meanwhile taking the search intention information of the image to be searched as a search condition. As compared with the solution in the prior art of performing search only based on the image, the present embodiment may greatly reduce the number of search results so that the user may quickly acquire desired information from the search results, and improves the efficiency of the user acquiring useful information therefrom.

In practical application, it is feasible to take a photo of an object to be recognized, and regard the photo of the object to be recognized as the image to be searched. The object to be recognized may be a plant (e.g., a tree, a flower, or the like), animal, clothes (e.g., backpack, coat or shoe), book, food, smart terminal (e.g., a mobile phone, tablet computer, a printer or the like), server, network device or the like. Alternatively, it is feasible to select, from a local image repository, a image including the object or content to be recognized as the image to be searched. Alternatively, it is feasible to acquire, from cloud, a image including the object or content to be recognized as the image to be searched.

It needs to be appreciated that the above image to be searched may be one or more sheets of images.

In practical application, the search intention information for the image to be searched may comprise at least one of text information, voice information and video information. Briefly speaking, the user may express the search intention for the image to be searched through at least one of the text, voice and video. For example, a image to be searched involving children's reading is taken as an example. The search intention information for the image to be searched comprises: price information described in the form of a text, for example, the price of the children's reading; information of a publishing house described in a voice form, for example, the children's reading is published by which publishing house; and content information described in a video form, for example, continuously-broadcast illustrations in the children's reading.

The manner of acquiring the search intention information varies with an implementation form of the search intention information. The text information in the search intention information may be input by various text input tools such as a keyboard, mouse, input pen, touch screen or the like from the perspective of the user; the text information input by the user through various text input tools may be received from the image search apparatus. The voice information in the search intention information may be input through a voice recording module such as a microphone from the perspective of the user; the voice information recorded by the voice recording module may be acquired from the perspective of the image searching apparatus. The video information in the search intention information may be shot through a video shooting module such as a camera from the perspective of the user; the video information shot by the video shooting module may be acquired from the perspective of the image searching apparatus.

In an optional implementation mode of step 101, namely, acquiring image to be searched and search intention information with respect to the image to be searched, the image searching apparatus may be activated first to enter a search page; then, the image searching apparatus obtains the image to be searched; then, the image searching apparatus receives the search intention information input by the user.

Specifically, a image-taking button (which may be a camera icon) may be arranged in the search page so that the user sends a image-taking instruction. When the user needs to search, he may activate the search function (namely, activate the image searching apparatus). A representation manner of activating the search function is to enter the search page provided by the image searching apparatus. Then, the user sends the image-taking instruction via the image-taking button on the search page; the image searching apparatus receives the image-taking instruction sent from the user, activates the image-taking module according to the instruction, and takes a image for the objection to be recognized to obtain the image to be searched. Specifically, the user may use the image-taking module towards the object to be recognized to take a image for the object to be recognized. Then, the image searching apparatus receives the search intention information input by the user.

In a specific implementation mode of the image searching apparatus receiving the search intention information input by the user, the image searching apparatus, after obtaining the image to be searched, automatically activates a sound recording module to record the user's voice to obtain the search intention information in the voice form.

In another specific implementation mode of the image searching apparatus receiving the search intention information input by the user, the image searching apparatus may record a video stream by a image-taking module which also has a video-shooting function and obtain audio information in the video stream as the search intention information. The image in the video stream is the image to be searched, and the audio information in the video stream is the search intention information in the voice form.

In a further specific implementation mode of the image searching apparatus receiving the search intention information input by the user, it is feasible to set on the search page at least one of a text input box, a voice recording button and a video shooting button, to enable the user to input the search intention information. Based on this, the user inputs the search intention information in the text input box on the search page; the image searching apparatus, after obtaining the image to be searched, receives the search intention information input by the user. Alternatively, upon completion of the image taking, the user sends a sound recording instruction through the sound-recording button on the search page, and the image searching apparatus, after obtaining the image to be searched, receives the sound-recording instruction, and activates the voice-recording module to record the voice representing the user's search intention to obtain the search intention information in the voice form. Alternatively, upon completion of the image taking, the user sends the video shooting instruction via a video button on the search page, and the image searching apparatus, after obtaining the image to be searched, receives the video shooting instruction, and activates the video shooting module to shoot video representing the user's search intention to obtain the search intention information in the video form.

In another optional implementation mode of step 101, namely, acquiring image to be searched and search intention information with respect to the image to be searched, original information input by the user is monitored in real time; judgement is made as to whether the user has a search demand according to the original information; when it is determined that the user has a search demand, he enters the search page, obtains the image to be searched, and regards the original information as the search intention information with respect to the image to be searched.

Specifically, the image searching apparatus monitors in real time the original information input by the user, and judges whether the user has a search demand according to the monitored original information, wherein the original information input by the user may comprise: at least one of text information, voice information and video information.

In an implementation mode, the image searching apparatus may preset a search demand word, the search demand word is a word or sentence reflecting that the user has a search demand, for example, the search demand word may be a word or sentence such as “where are you going”, “how much”, “where is the place of origin of this vegetable”, “when will the move be put on”, or “what day is today”. Based on this, the image searching apparatus may specifically judge whether the monitored original information belongs to a preset search demand word; when the judgment result is yes, it is determined that the user has a search demand; when the judgment result is no, it is determined that the user does not have a search demand.

When the user is judged as having the search demand, the image searching apparatus activates the search result, and a representation manner of activating the search function is to enter the search page. Then, the image searching apparatus takes a image for the object to be recognized to obtain the image to be searched, and regards the monitored original information as the search intention information of the image to be searched.

In an optional embodiment mode, the image searching apparatus, after judging that the user has a search demand, automatically activates the image-taking module to take a image for the object to be recognized to obtain the image to be searched. This implementation mode does not limit a sequential order of the image searching apparatus activating the image-taking module and entering the search page.

In another optional embodiment mode, it is feasible to set the image-taking button (which may be a camera icon) on the search page so that the user sends the image-taking instruction. The image searching apparatus enters the search page after judging that the user has a search demand. The user sends the image-taking instruction through the image-taking button on the search page; the image searching apparatus receives the image-taking instruction sent from the user, activates the image-taking module according to the instruction, and takes a image for the object to be recognized to obtain the image to be searched.

In an optional implementation mode of step 102, namely, obtaining a search result according to the image to be searched and the search intention information, the image searching apparatus may search according to the above image to be searched to obtain an initial search result, and perform secondary search in the initial search result according to the search intention information to obtain a final search result.

In another optional implementation mode of step 102, namely, obtaining a search result according to the image to be searched and the search intention information, the image searching apparatus extracts feature information of the image to be searched; performs merge processing for the feature information and search intention information to obtain a search key word; performs search directly according to the search key word to obtain a search result.

It needs to be appreciated that during the above merge processing, if the search intention information includes voice information, it is feasible to convert the voice information into text information, and then perform merge processing for the feature information and text information.

In the embodiment of the present disclosure, it is feasible to employ many general purpose extraction algorithm to extract features of the image to be searched, for example, employ bag of word (BOW) algorithm to extract an uncertain number of features in the image to be searched, each feature corresponding to a feature vector, so that it is feasible to extract a plurality of features from one image.

Further optionally, the image searching apparatus may acquire a reverse index corresponding to the feature information and a reverse index corresponding to the search intention information; then, perform weighting processing for the reverse index corresponding to the feature information and the reverse index corresponding to the search intention information to obtain the above search key word.

For example, the image searching apparatus may respectively employ the feature information and search intention information to search from a reverse index repository to thereby obtain the reverse index corresponding to the feature information and reverse index corresponding to the search intention information, wherein the feature information and the search intention information may share one reverse index repository or use an independent reverse index repository.

Optionally, the feature information and search intention information generally correspond to a plurality of reverse indexes. It is feasible to respectively obtain N foremost reverse indexes corresponding to the feature information and search intention information, and perform weighting processing for the 2N reverse indexes; then, sort weighting processing results, and select M foremost weighting processing results as a search key word, wherein N and M each are a natural number, and M is smaller than or equal to N.

With the method provided by the embodiment of the present disclosure being employed, after the user sees a poster of a certain movie when he takes a subway, if he wants to learn about information of the movie such as showing schedule and price, he may use his mobile phone to enter a search page, takes a image of this poster and records voice information about query for the showing cinemas and price, then use BOW or other extraction algorithms to extract the feature information of the poster, convert this voice information into text information, merge the feature information with the text information, generate the search key word, use the search key word to search, obtain a search result related to showing and price of the cinema, and display the obtained search result to the user.

Alternatively, with the method provided by the embodiment of the present disclosure being employed, after the user sees a poster of a certain movie when he takes a subway, if he wants to learn about information of the movie such as showing schedule and price, he may activate the sound-recording function on the mobile phone to record voice information about query for showing cinemas and price of the movie. When it is judged according to the voice information that the user has a search demand, the user enters the search page and activates the image-taking module (e.g., a camera), the user takes a image of this poster through the image-taking module, then uses BOW or other extraction algorithms to extract the feature information of the poster, converts this voice information into text information, merges the feature information with the text information, generates the search key word, uses the search key word to search, obtains a search result related to showing and price of the cinema, and displays the obtained search result to the user.

As can be seen from the above, in the present disclosure, search is performed simultaneously according to the image to be searched and the search intention information, and the obtained search result is a search result which is closest to the user's search intention. As compared with the prior art, the present disclosure substantially reduces the number of search results and therefore may improve the user's efficiency in acquiring useful information from the search results.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

FIG. 2 is a block diagram of a image searching apparatus according to an embodiment of the present disclosure. As shown in FIG. 2, the method comprises an acquiring module 21 and a searching module 22.

The acquiring module 21 is configured to acquire a image to be searched and search intention information with respect to the image to be searched.

The searching module 22 is configured to obtain a search result according to the image to be searched and the search intention information acquired by the acquiring module 21.

In an optional embodiment, the acquiring module 21 is specifically configured to:

enter a search page;

obtain the image to be searched;

receive the search intention information input by the user.

In an optional embodiment, the acquiring module 21 is specifically configured to:

monitor in real time original information input by the user;

judge whether the user has a search demand according to the original information;

when it is determined that the user has the search demand, enter the search page, obtain the image to be searched, and regard the original information as the search intention information with respect to the image to be searched.

Furthermore, upon judging whether the user has a search demand according to the original information, the acquiring module 21 is specifically configured to:

judge whether the original information belongs to a preset search demand word;

when the judgment result is yes, determine that the user has a search demand;

when the judgment result is no, determine that the user does not have the search demand.

Optionally, the above search intention information may comprise: at least one of text information, voice information and video information.

In an optional embodiment, the searching module 22 is specifically configured to extract feature information of the image to be searched; perform merge processing for the feature information and search intention information to obtain a search key word; perform search according to the search key word to obtain a search result.

Further optionally, upon performing merge processing for the feature information and search intention information, the searching module 22 may be specifically configured to: acquire a reverse index corresponding to the feature information and a reverse index corresponding to the search intention information; then, perform weighting processing for the reverse index corresponding to the feature information and the reverse index corresponding to the search intention information to obtain the search key word.

For example, the searching module 22 may respectively employ the feature information and search intention information to search from a reverse index repository to thereby obtain the reverse index corresponding to the feature information and reverse index corresponding to the search intention information, wherein the feature information and the search intention information may share one reverse index repository or use an independent reverse index repository.

For example, in the case that the feature information and the search intention information respectively correspond to a plurality of reverse indexes, the searching module 22 may be specifically configured to respectively obtain N foremost reverse indexes corresponding to the feature information and the search intention information, and perform weighting processing for the 2N reverse indexes; then, sort weighting processing results, and select M foremost weighting processing results as a search key word, wherein N and M each are a natural number, and M is smaller than or equal to N.

The image searching apparatus provided by the present embodiment acquires the image to be searched and the search intention information with respect to the image to be searched, and meanwhile obtains a search result according to the image to be searched and the search intention information. Since the image searching apparatus of the present embodiment may perform search simultaneously according to the image to be searched and the search intention information, and the obtained search result is a search result which is closest to the user's search intention. As compared with the prior art, the present disclosure substantially reduces the number of search results and therefore may improve the user's efficiency in acquiring useful information from the search results.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

What is claimed is:

1. A image searching method, wherein the method comprises:
acquiring a image to be searched and search intention information with respect to the image to be searched;
obtaining a search result according to the image to be searched and the search intention information.

2. The method according to claim 1, wherein the acquiring a image to be searched and search intention information with respect to the image to be searched comprises:
entering a search page;
obtaining the image to be searched;
receiving the search intention information input by the user.

3. The method according to claim 1, wherein the acquiring a image to be searched and search intention information with respect to the image to be searched comprises:
monitoring in real time original information input by the user;
judging whether the user has a search demand according to the original information;
when it is determined that the user has the search demand, entering the search page, obtaining the image to be searched, and regarding the original information as the search intention information with respect to the image to be searched.

4. The method according to claim 3, wherein the judging whether the user has a search demand according to the original information comprises:
judging whether the original information belongs to a preset search demand word;
when the judgment result is yes, determining that the user has a search demand;
when the judgment result is no, determining that the user does not have the search demand.

5. The method according to claim 1, wherein the search intention information comprises: at least one of text information, voice information and video information.

6. The method according to claim 1, wherein the obtaining a search result according to the image to be searched and the search intention information comprises:
extracting feature information of the image to be searched;
performing merge processing for the feature information and search intention information to obtain a search key word;
performing search according to the search key word to obtain a search result.

7. The method according to claim 6, wherein the performing merge processing for the feature information and search intention information to obtain a search key word comprises:
acquiring a reverse index corresponding to the feature information and a reverse index corresponding to the search intention information;
performing weighting processing for the reverse index corresponding to the feature information and the reverse index corresponding to the search intention information to obtain the search key word.

8-14. (canceled)

15. An apparatus, comprising
one or more processors;
a memory;
one or more programs stored in the memory and configured to execute the following operation when executed by the one or more processors:
acquiring a image to be searched and search intention information with respect to the image to be searched;
obtaining a search result according to the image to be searched and the search intention information.

16. A non-volatile computer storage medium in which one or more programs are stored, an apparatus being enabled to execute the following operations when said one or more programs are executed by the apparatus:
acquiring a image to be searched and search intention information with respect to the image to be searched;
obtaining a search result according to the image to be searched and the search intention information.

17. The Apparatus according to claim 15, wherein the operation of acquiring a image to be searched and search intention information with respect to the image to be searched comprises:
entering a search page;
obtaining the image to be searched;
receiving the search intention information input by the user.

18. The Apparatus according to claim 15, wherein the operation of acquiring a image to be searched and search intention information with respect to the image to be searched comprises:
monitoring in real time original information input by the user;
judging whether the user has a search demand according to the original information;
when it is determined that the user has the search demand, entering the search page, obtaining the image to be searched, and regarding the original information as the search intention information with respect to the image to be searched.

19. The Apparatus according to claim 18, wherein the operation of judging whether the user has a search demand according to the original information comprises:
judging whether the original information belongs to a preset search demand word;
when the judgment result is yes, determining that the user has a search demand;
when the judgment result is no, determining that the user does not have the search demand.

20. The Apparatus according to claim 15, wherein the search intention information comprises: at least one of text information, voice information and video information.

21. The Apparatus according to claim 15, wherein the operation of obtaining a search result according to the image to be searched and the search intention information comprises:
extracting feature information of the image to be searched;
performing merge processing for the feature information and search intention information to obtain a search key word;
performing search according to the search key word to obtain a search result.

22. The Apparatus according to claim 21, wherein the operation of performing merge processing for the feature information and search intention information to obtain a search key word comprises:
acquiring a reverse index corresponding to the feature information and a reverse index corresponding to the search intention information;
performing weighting processing for the reverse index corresponding to the feature information and the reverse index corresponding to the search intention information to obtain the search key word.
